(19) United States
(12) Patent Application Publication
(10) Pub. No.: US 2002/0087390 A1
(43) Pub. Date: Jul. 4, 2002

(54) Method and system of using collective human intelligence to logically group related items

(76) Inventors: Robert G. Weathersby, Rye, NH (US); Kelly L. Frey, Revere, MA (US); Kevin Dombrowski, Portsmouth, NH (US)

Correspondence Address: Supervisor, Patent Prosecution Services, PIPER MARBURY RUDNICK & WOLFE LLP, 1200 Nineteenth Street, N.W., Washington, DC, 20036-2412, US

(21) Appl. No.: 09/969,814

(22) Filed: Oct. 4, 2001

Related U.S. Application Data
(60) Provisional application No. 60/237,391, filed on Oct. 4, 2000.

(51) Int. Cl. G06F 17/60

(52) U.S. Cl. 705/10

(57) ABSTRACT

A method and system for performing cluster analysis, particularly in relation to methods of providing purchase recommendations based on analysis of online shopping cart aggregated selections determined using prior collective user activities. One variation of the invention includes the following functions: 1) data is collected at a partner site on a network, such as the Internet; 2) a data stream from the network site is transmitted to a server, and the data is parsed and stored; 3) query logic is used on the database to produce query lists by selected variables; 4) recommendation publishing is invoked by the partner site; 5) recommended data produced using relationships among the collected data is transmitted to the partner site; and 6) the partner site publishes the recommended data.

This application claims priority from U.S. Provisional Application Serial No. 60/237,391 filed Oct. 4, 2000, of Robert G. Weathersby, et al., titled “METHOD AND SYSTEM OF USING COLLECTIVE HUMAN INTELLIGENCE TO LOGICALLY GROUP RELATED ITEMS.” The entirety of that provisional application is incorporated herein by reference.

### BACKGROUND OF THE INVENTION

1. Field of the Invention

The present invention relates to the field of cluster analysis, and in particular to a unique method of providing purchase recommendations based on analysis of online shopping cart aggregated selections, determined using prior collective user activities.

2. Background of the Technology

Providing contextually relevant product recommendations to consumers during a shopping experience increases the chances of an actual purchase and improves the satisfaction level of the shopper with the shopping experience. Various processes have been proposed to automatically generate contextually relevant recommendations. The most successful processes consistently capture consumer behavior in a non-intrusive manner, aggregate that behavior, and use the results to derive product purchase recommendations to influence subsequent consumer's behavior.

Some solutions to this problem have used collaborative filtering to relate certain personal information of the consumer to their specific product selection. In some instances, demographic information of prior purchasers is related to those customers' buying decisions and the relationships are used to make product recommendations to subsequent consumers with similar demographic profiles. An advancement on this technique adds rating/utilization information from prior users to assist in returning relevant recommendations to subsequent users. Another advancement traces the navigation of a prior user to predict “next steps” for a subsequent user. The problem with all of these methods is that they deal with mean/average consumer activities (returning less reliable information/recommendations the further from “average” behavior the activity migrates).

Prior inventions have also focused on actual purchase decisions. Since over 65% of online shopping carts that are initiated are abandoned, focus on actual purchase decisions loses ⅔ of relevant consumer “grouping” behavior and is skewed by a number of factors unrelated to any inherent/natural clustering/relationship of items (e.g. resistance to paying shipping costs, number of clicks required to complete a transaction, surprises over total amount of selections, etc.).

### SUMMARY OF THE INVENTION

The present invention provides a system of rules and method of use implemented via a software application that operates on unique selections of items placed in an online shopping cart. The product utilizes the collective intelligence of numerous human agents actively selecting items from a finite product catalogue for inclusion within a series of unique online shopping carts. These unique occurrences (items placed into a unique shopping cart) are analyzed for statistically significant clusters of items that are repetitively associated with each other (selected within the same shopping cart session).

Thus, the present invention provides a method and system for performing cluster analysis, particularly in relation to methods of providing purchase recommendations based on analysis of online shopping cart aggregated selections determined using prior collective user activities. One variation of the invention includes the following functions: 1) data is collected at a partner site on a network, such as the Internet; 2) a data stream from the network site is transmitted to a server, and the data is parsed and stored; 3) query logic is used on the database to produce query lists by selected variables; 4) recommendation publishing is invoked by the partner site; 5) recommended data produced using relationships among the collected data is transmitted to the partner site; and 6) the partner site publishes the recommended data.

Various problems of the prior art addressed by the present invention include: 1) for content sites, revenue models are difficult to establish, other than advertising/sponsorship; 2) potential consumers enter the site, fail to find what they want quickly, and leave, never to return; 3) consumers are left on their own to find what content or products are most appropriate for their needs; and 4) there is no mechanism on many of the existing sites to lead users to the most relevant and personally useful information at the site.

Additional advantages and novel features of the invention will be set forth in part in the description that follows, and in part will become more apparent to those skilled in the art upon examination of the following or upon learning by practice of the invention.

### BRIEF DESCRIPTION OF THE FIGURES

In the drawings:

FIG. 1 presents a pictogram illustrating product selection by three users, in accordance with an embodiment of the present invention;

FIG. 2 shows a system diagram of various components of an example system, in accordance with an embodiment of the present invention;

FIG. 3 contains a pictogram of an example process of data flow, in accordance with an embodiment of the present invention;

FIG. 4 is a second example of a system diagram of various components of an example system, in accordance with an embodiment of the present invention;

FIG. 5 presents an example flow chart of a method of operation, in accordance with an embodiment of the present invention;

FIGS. 6-7 show example graphical user interface (GUI) screens and illustrated functionality, in accordance with an embodiment of the present invention;

FIG. 8 contains an example table of favorites and statistical profiling, in accordance with an embodiment of the present invention; and

FIGS. 9-32 present various example GUI screens, in accordance with embodiments of the present invention.

### DETAILED DESCRIPTION

The present invention comprises a content sorting and delivery tool and favorites (recommendations) sorting tool based on common favorites matching. Embodiments of the present invention create systems for consumer generated content (favorites) to drive incremental site value (e.g., more loyalty, more purchases). The present invention creates a more compelling consumer experience, by performing the following: 1) the invention creates demand by pushing relevant content to potential consumers of which they would have been previously unaware; 2) the invention increases consumer satisfaction and loyalty, thus encouraging return visits; and 3) the invention draws in new site users based on a recommendation from a trusted source. The invention also provides an additional reason for curious browsers to register at the site.

In contrast to the prior art, the present invention more closely tracks the real relationships that exist between products within a product catalogue by focusing upon the intelligent “collecting/sorting” activity of numerous users in the shopping cart experience unrestrained by other purchase related criteria.

The present invention recognizes that context sensitive product recommendations are not so much influenced by prior characteristics/ratings of an individual as they are by the immediate “search/selection task”—i.e., it is not so much the nature of the searcher as the nature of the specific search that determines “relevance”. For example, if a grandmother has a continuous history of purchasing romance novels, a collaborative filtering system (such as the one used by Amazon) would routinely provide further recommendations within this genre—however, if that customer now buys a Harry Potter book for a grandchild (a statistically aberrant selection), the subsequent recommendations provided by collaborative filtering will become skewed toward what was essentially a “one-time” behavior. With the present invention, prior purchase decisions of the individual are irrelevant—the invention attempts to return “similar items” based upon the immediate needs of the user (if you are looking for Harry Potter today, it will return a host of related items, but if you look for romance novels tomorrow it will only return items related to romance novels).

The present invention is based, at least in part, upon self-organizational behavior of numerous intelligent agents, each involved in collecting/groups elements/items. A biological analog would be the sorting/collecting behavior of ants-assume each ant has a specific immediate task of sorting/collecting items (such as ant larvae) with unique relationships/characteristics (see March 2000 issue of Scientific American for article). Using each ant as an independent intelligent agent, an ant swarm can effectively sort through a huge variety of items to create groups of items based upon specific/predetermined criteria. The present invention uses “collective human intelligence”—each consumer who initiates a shopping cart acts as an agent selecting unique sets of items. If, collectively, thousands of consumers consistently create similar sets (pairings) of items, then once one of the items in the set/pairing is selected by a subsequent user, the other unique elements of the set would be contextually relevant for presentation to that subsequent user. The product functionality is divided into three phases: 1) data collection; 2) aggregation and analysis; and 3) contextually relevant publication of “recommendations.”

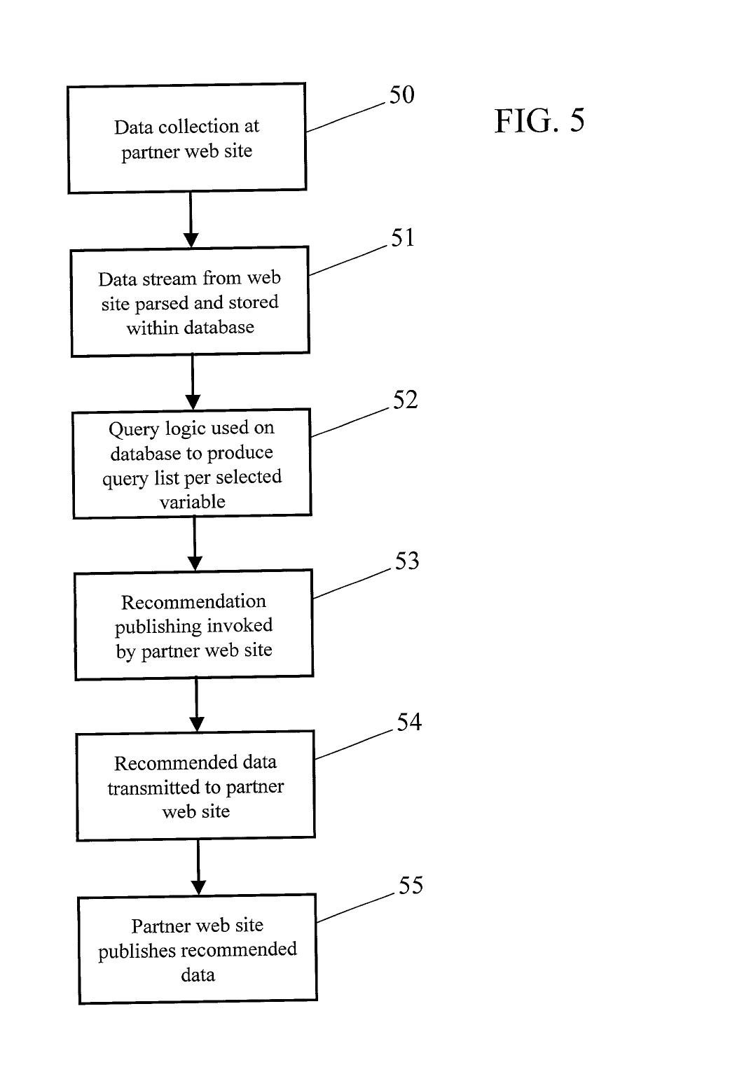

As shown in FIG. 5, data collection is conducted at a web site containing a finite product catalogue (the “partner website”) 50. The web site can be, for example, a site on the Internet or other network, the site being housed on a server, such as a personal computer (PC), minicomputer, microcomputer, main frame computer, or other device having a processor and optionally including or coupled to a repository, such as a database. Each time a consumer adds an item from the catalogue to their online shopping cart, the partner sends a data collection entity a data stream via http. The data-stream is sent by invoking a proprietary JAVA or COM object provided to the partner by the data collection entity. The data stream consists of a predefined set of attributes, including partner identifier, product identifier, product parent identifier (a logical taxonomic relationship mutually determined by the data collection entity and the partner), product url, workstation identification, consumer session identification.

Once received, the stream is parsed and stored within a proprietary database 51. Proprietary structured query language (SQL) logic is run on the tables, resulting in a querying list per partner, per product, of other products selected by that partners' consumers within a single online shopping session (i.e. other items in the same shopping cart) 52.

In one embodiment, the invention operates via a network, such as the Internet (e.g., in a hosted or Application Service Provider (ASP) fashion). In another embodiment, the invention operates internally within a company or other user's environment, including, for example, an intranet. The software at user sites may be installed remotely via a network, such as the Internet, or it may wholly operate from a remote location, such as from a server on the network using software, such as applets.

The present implementation uses the following logic for parsing the data:

a. Create and populate from data-stream a “product_selections” table (unique to each partner) of all products placed in a shopping cart during defined period, along with the number of occurrences of each product (if you viewed this result set in “descending” order by number of occurrences of each product, you would be looking at the “hot products” at the top of the order—the most selected products down to the least selected products).

b. For each product in first step, match all rows of each product calculated against an image of the product_selections table to find the session_id's in which each product was selected.

c. Probe a second image of the product_selections table to find all OTHER products selected in the same session as the product in question.

d. Store the results of these queries in a “fav_prod_recommendations” table, which is referenced during a subsequent user's shopping cart experience at that partner's site (see below for publication process).

e. Results may be limited by reducing “product_selections” table to the top 30%, 40%, n % of products, count “OTHER” products and return the top n % of OTHER products selected along with product in question or products outside standard statistical ranges (2 SDs), etc.

f. Results may be expanded to 3rd, 4th, nth image of the product_selections table—i.e., finding a third product that is associated with two other products or a 4th product associated with three other products (and also limited to those higher order selections that are statistically significant).

This manifestation captures the relationships that exist between products from collective intelligence/selection activities of shopping cart users (but does not relate user profiles/non-shopping cart selection activity to products). Another manifestation can also capture relationships related to other types of clustered items: instead of a product_selections table, you could utilize a favorite_master table that stores clusters of items selected by member_id rather than by session_id. Favorites/recommended products that are actively selected by users are returned in response to calls related to one of the favorites in the cluster—without reference to any user characteristics/profile/demographics. The intent is to relate “items to items”, not “people to items” or “people to people” as in the prior art.

Recommendation publishing is invoked when the partner's web site is about to display a partner page containing a product that was previously included within a shopping cart containing other products 53. The recommendation returned are the other statistically significant (or other criteria) products from prior shopping carts. The partner's page invokes a predefined url. The url identifies the partner, page, product of immediate interest. The data collection entity publishes other relevant product selections (“the recommendation(s)”) into the defined page area per the algorithm above 54, 55.

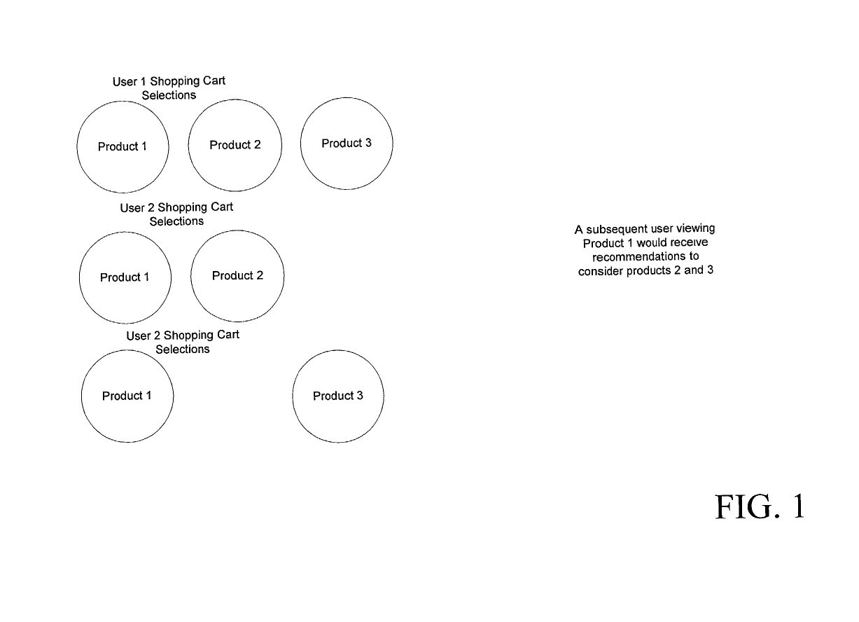

The algorithm's sensitivity can be adjusted—it can return any item that has been previously selected within the same shopping cart session (as illustrated in FIG. 1) or can refine returned items to high(er) levels of statistical significance.

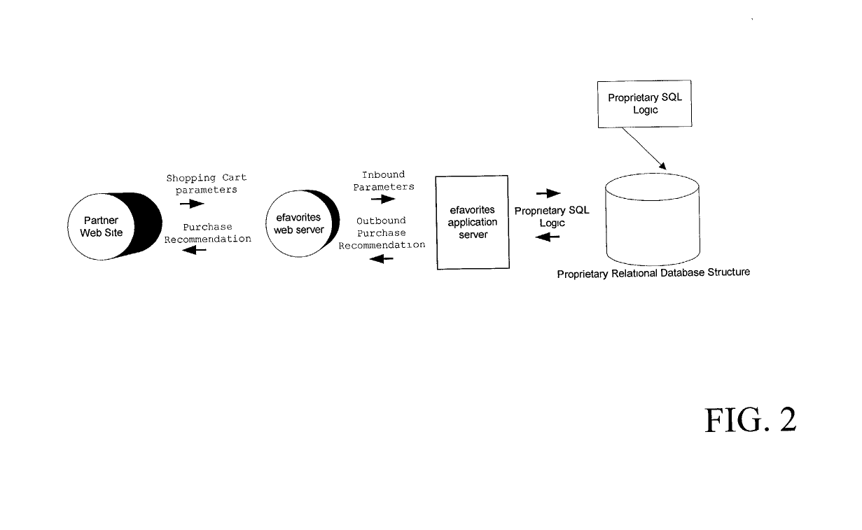

FIG. 2 shows a system diagram of various components of an example system, in accordance with an embodiment of the present invention.

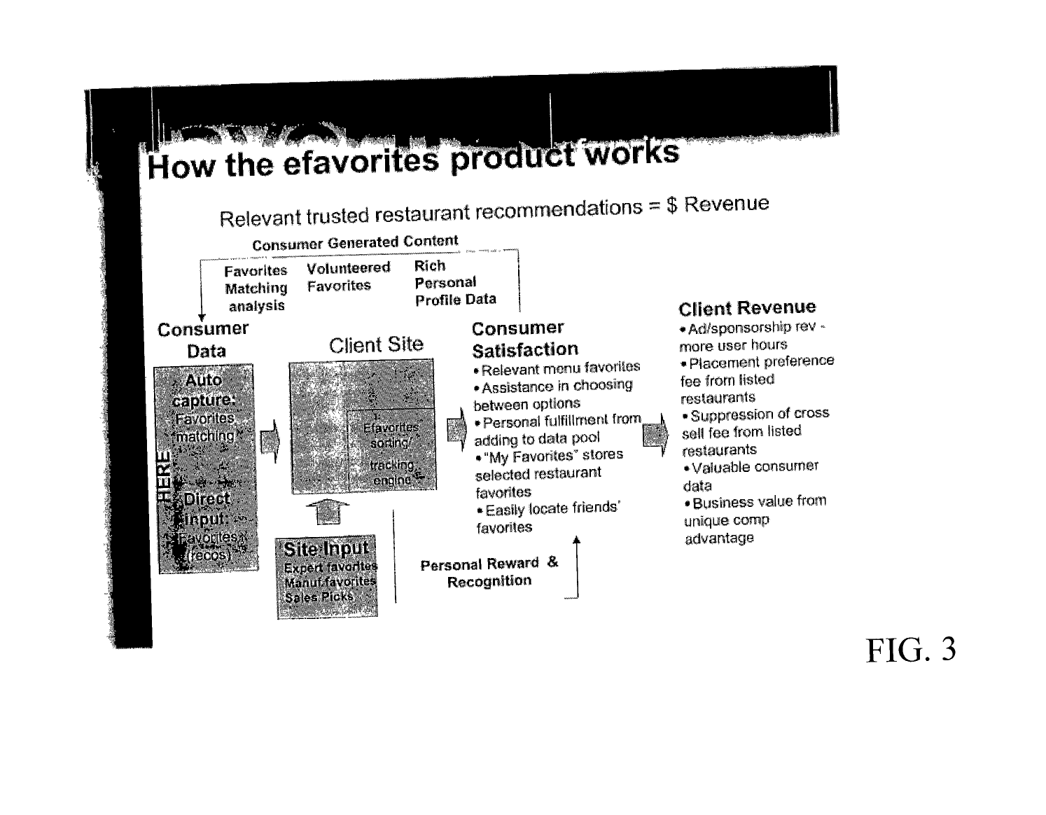

FIG. 3 contains a pictogram of an example process of data flow, in accordance with an embodiment of the present invention.

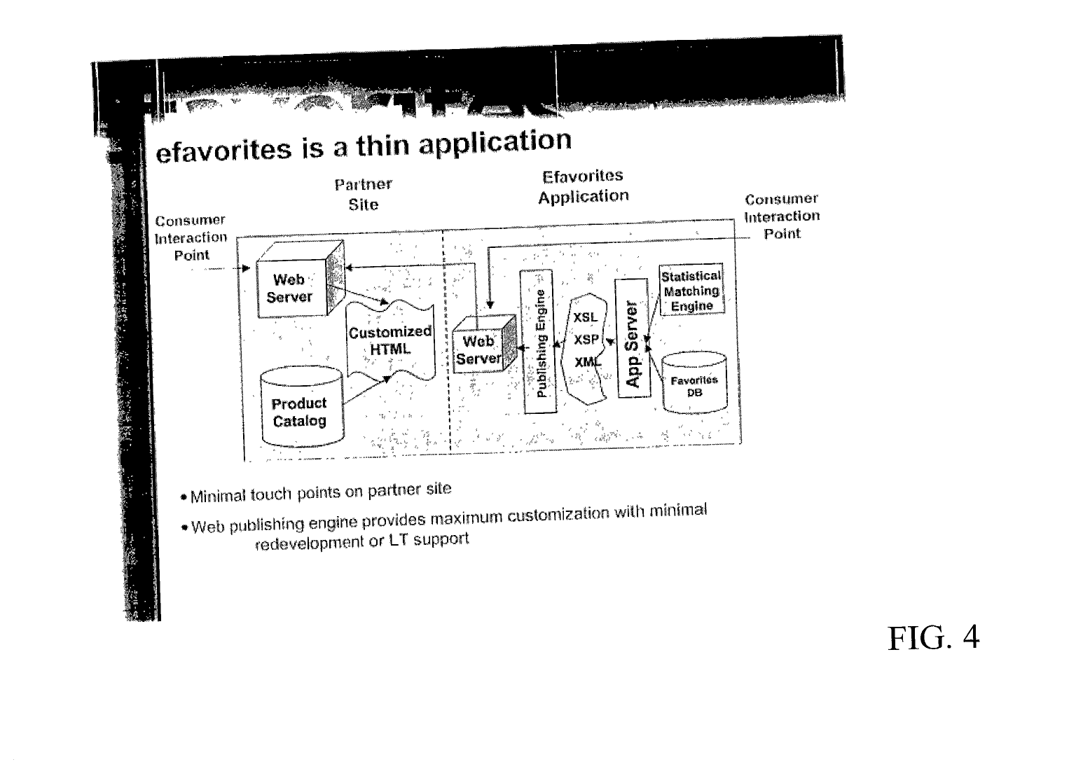

FIG. 4 is a second example of a system diagram of various components of an example system, in accordance with an embodiment of the present invention.

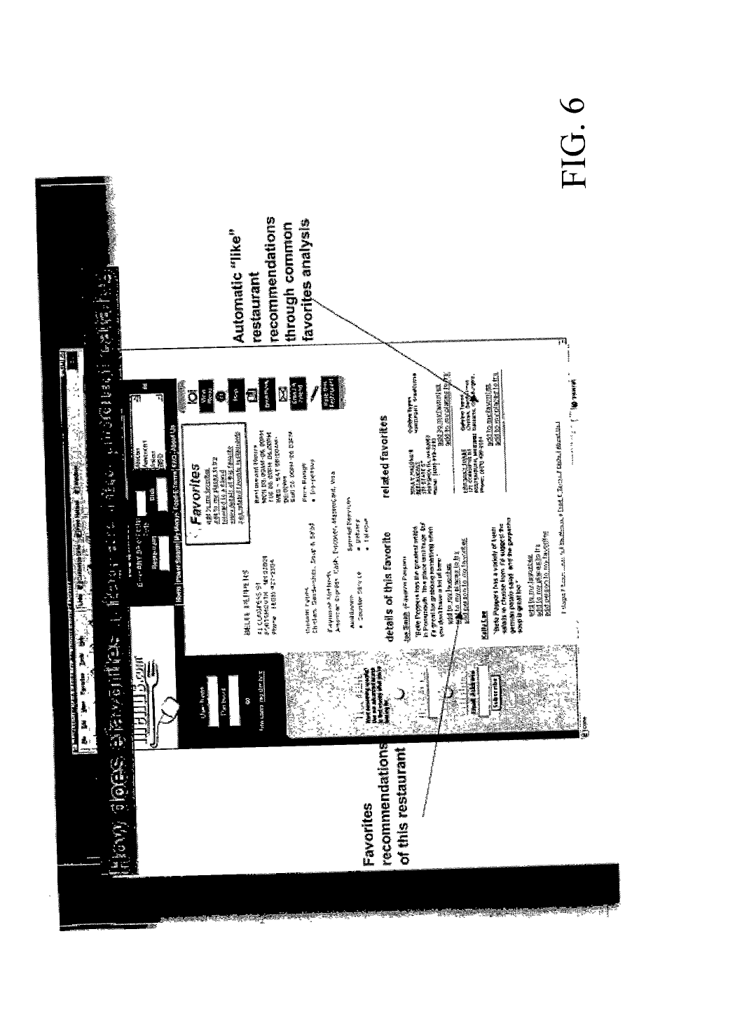

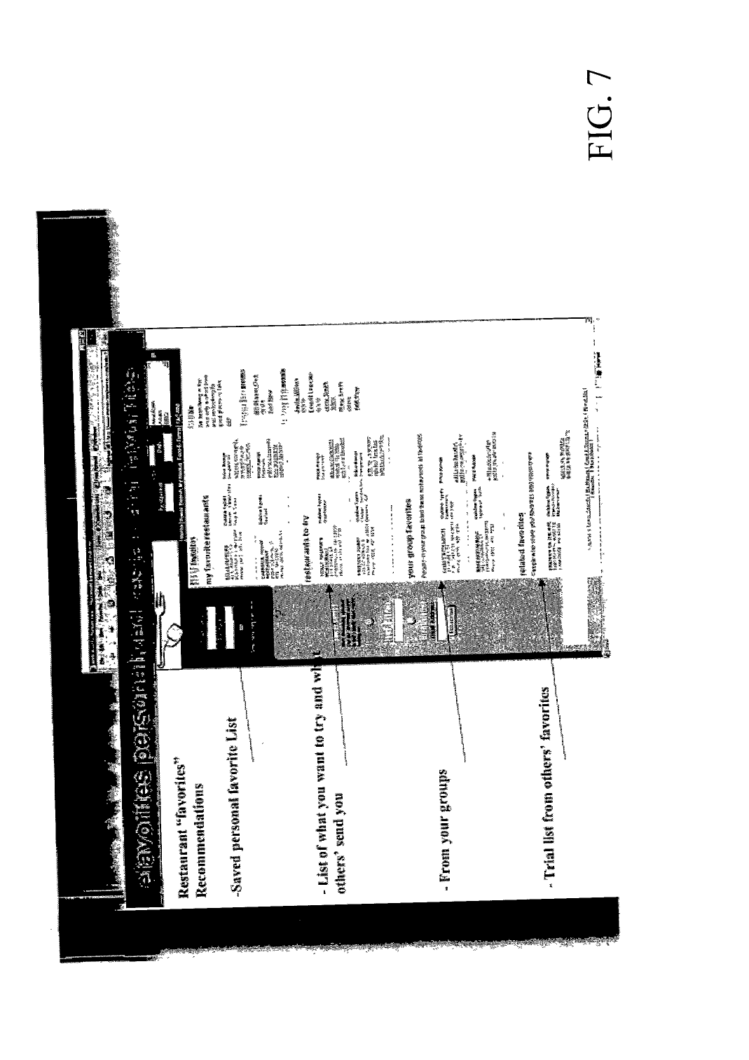

FIGS. 6-7 show example graphical user interface (GUI) screens and illustrated functionality, in accordance with an embodiment of the present invention.

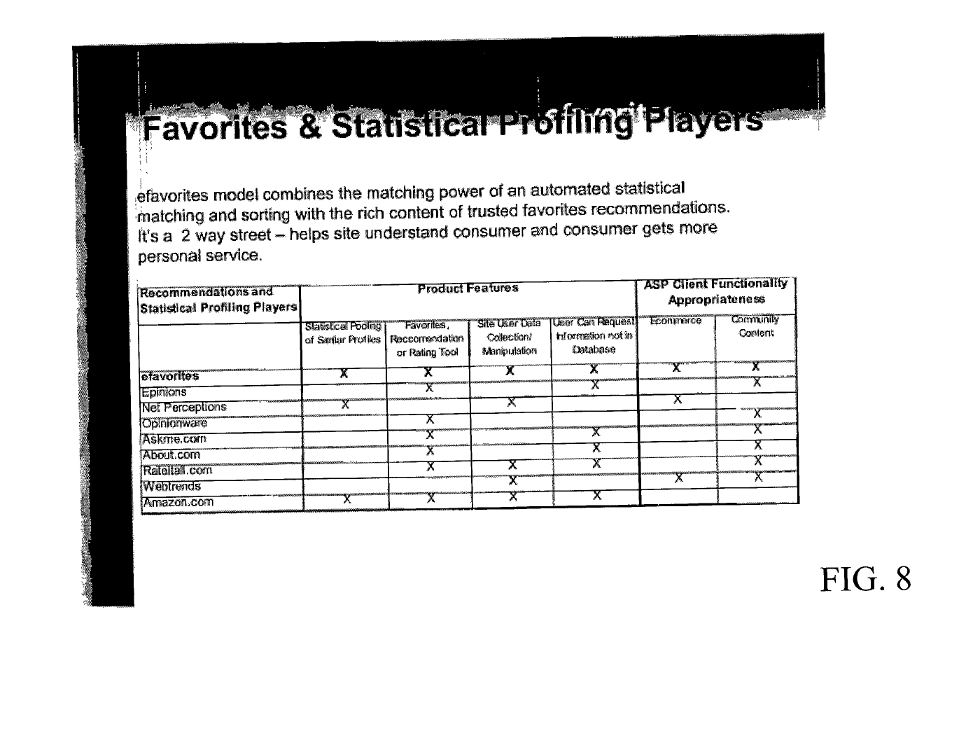

FIG. 8 contains an example table of favorites and statistical profiling, in accordance with an embodiment of the present invention.

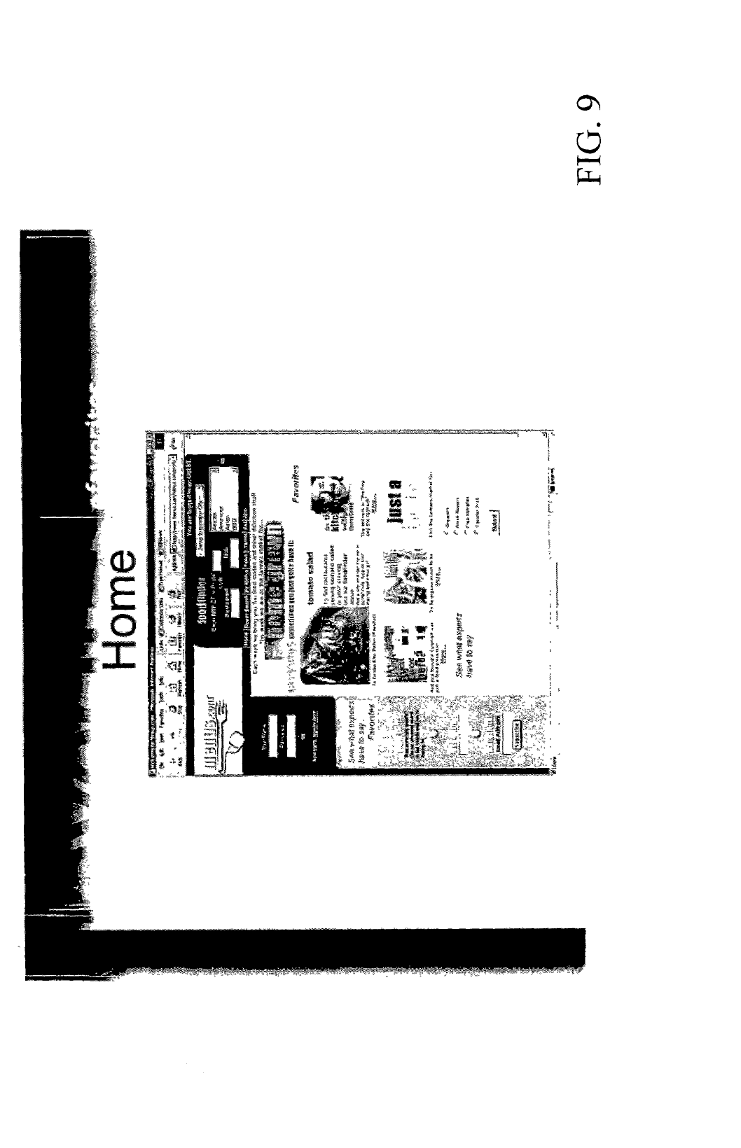

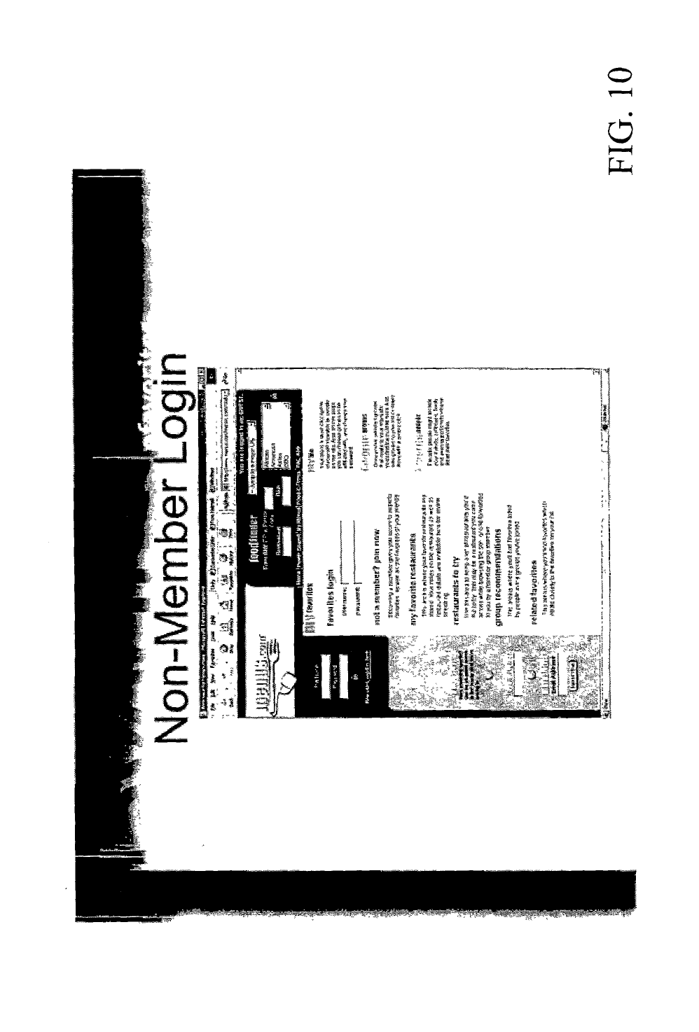

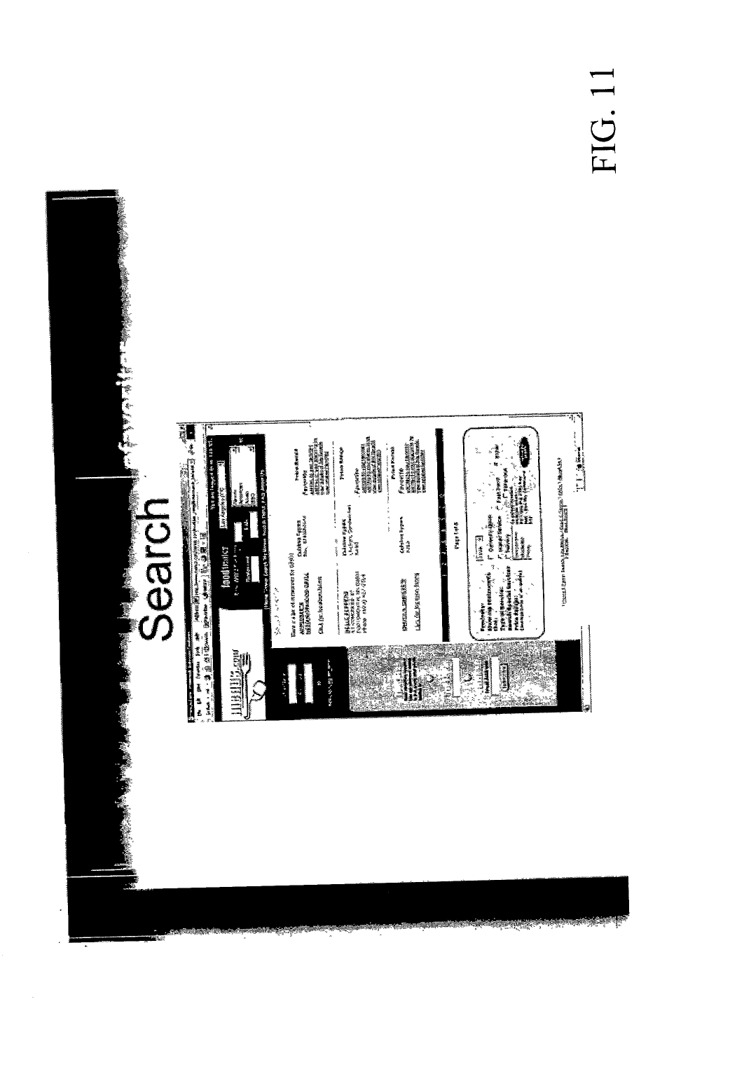

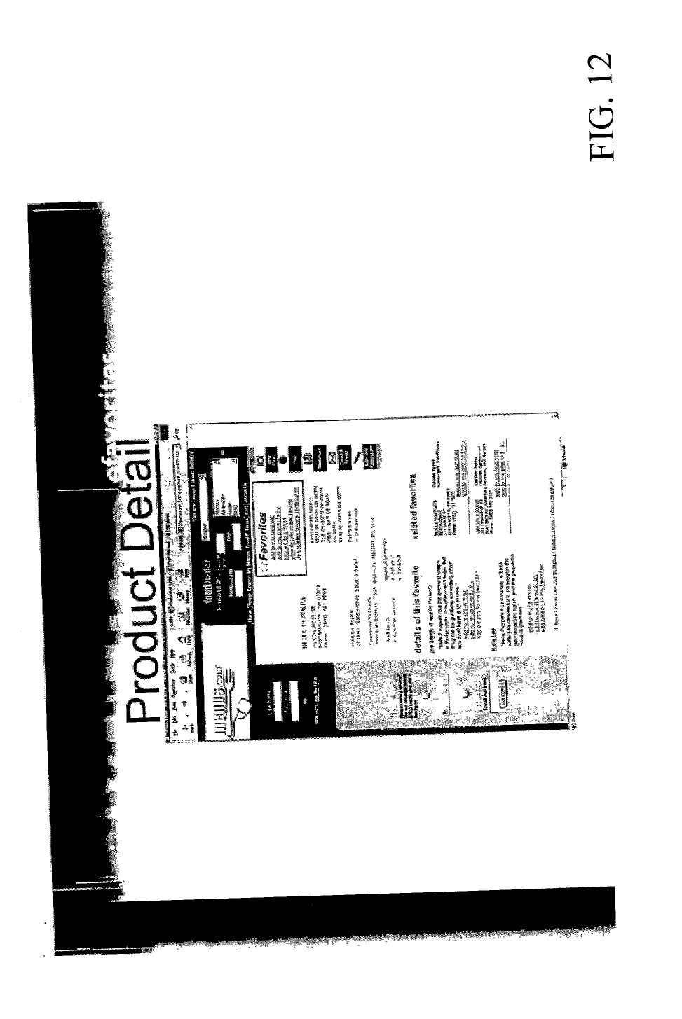

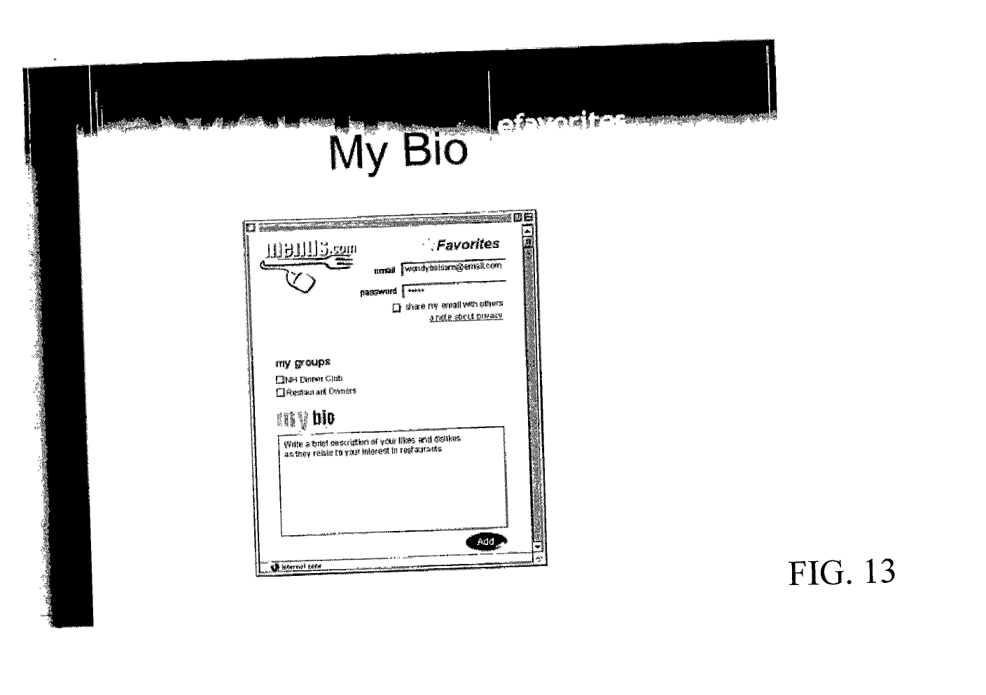

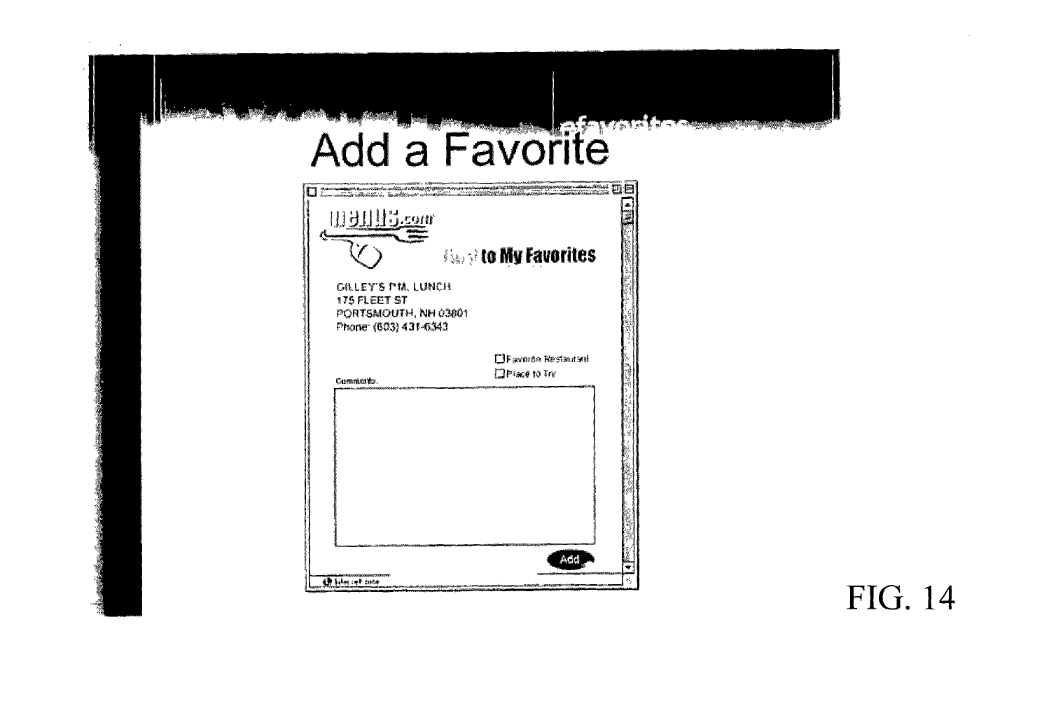

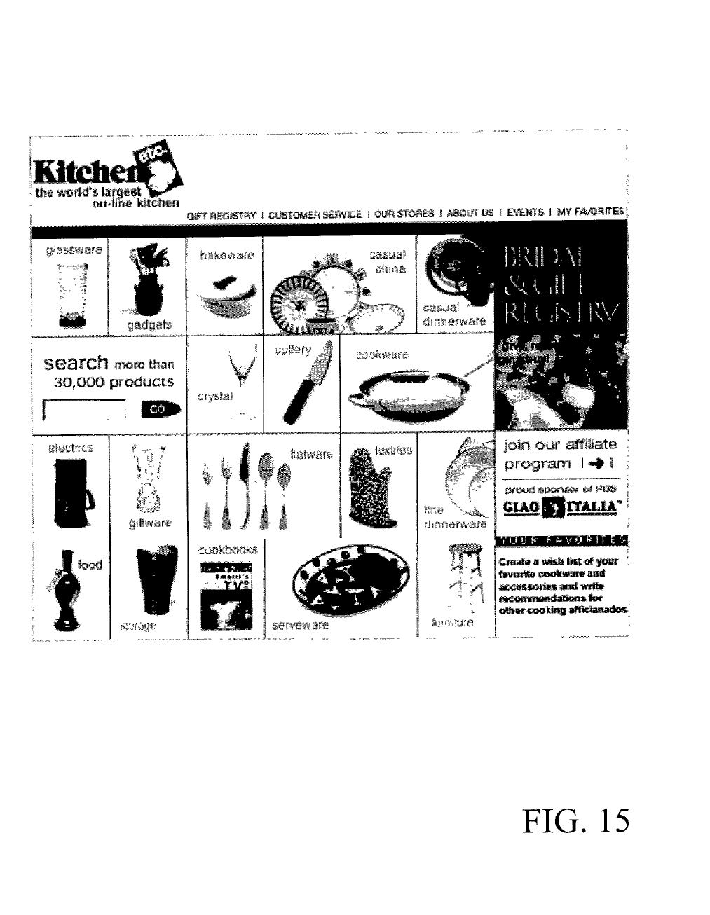

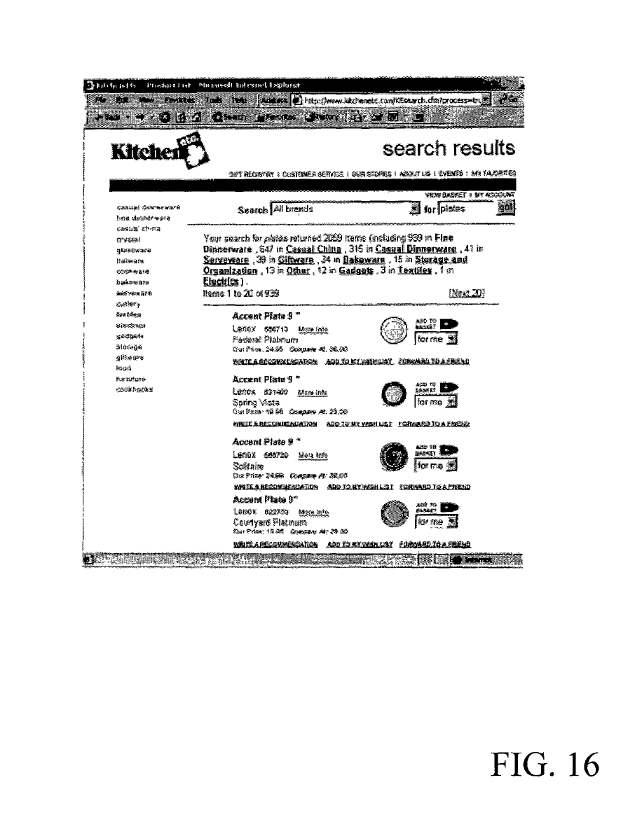

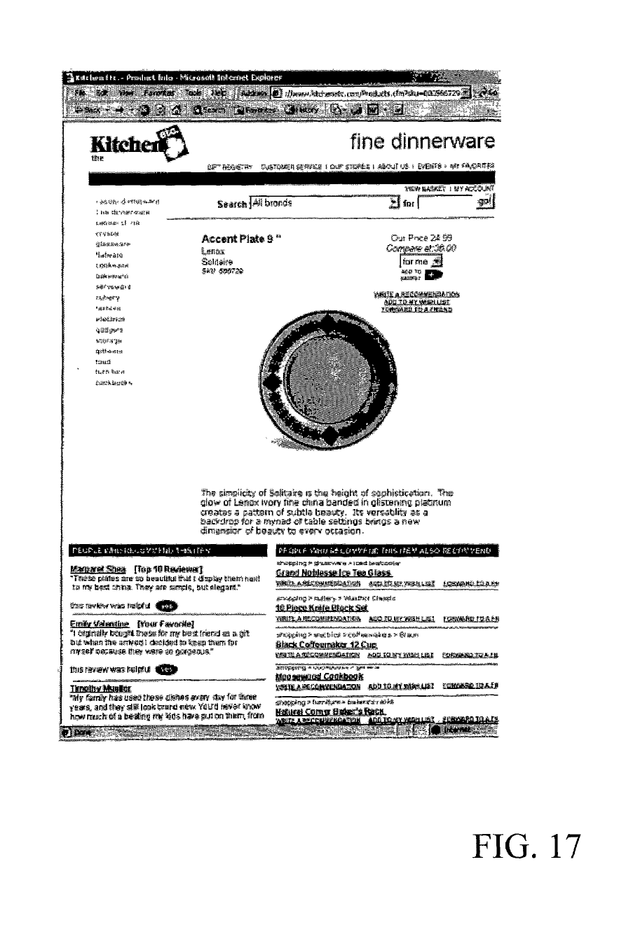

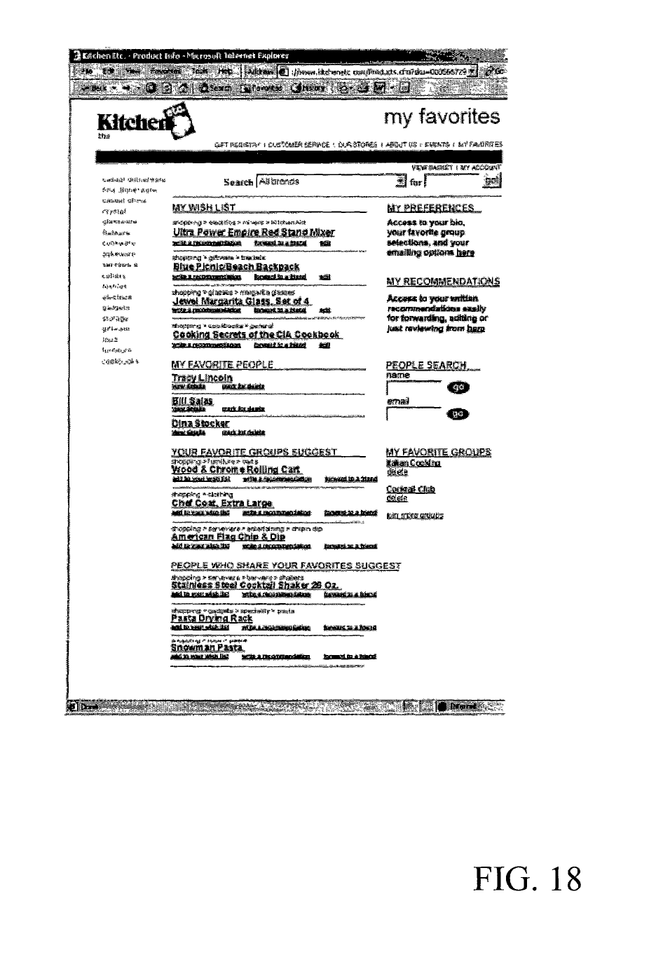

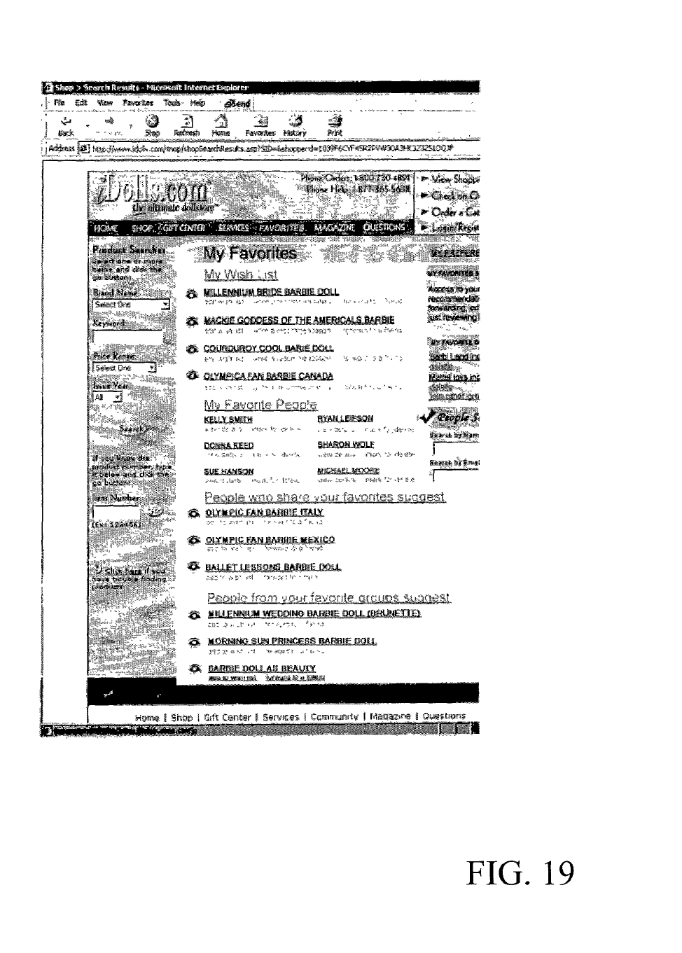

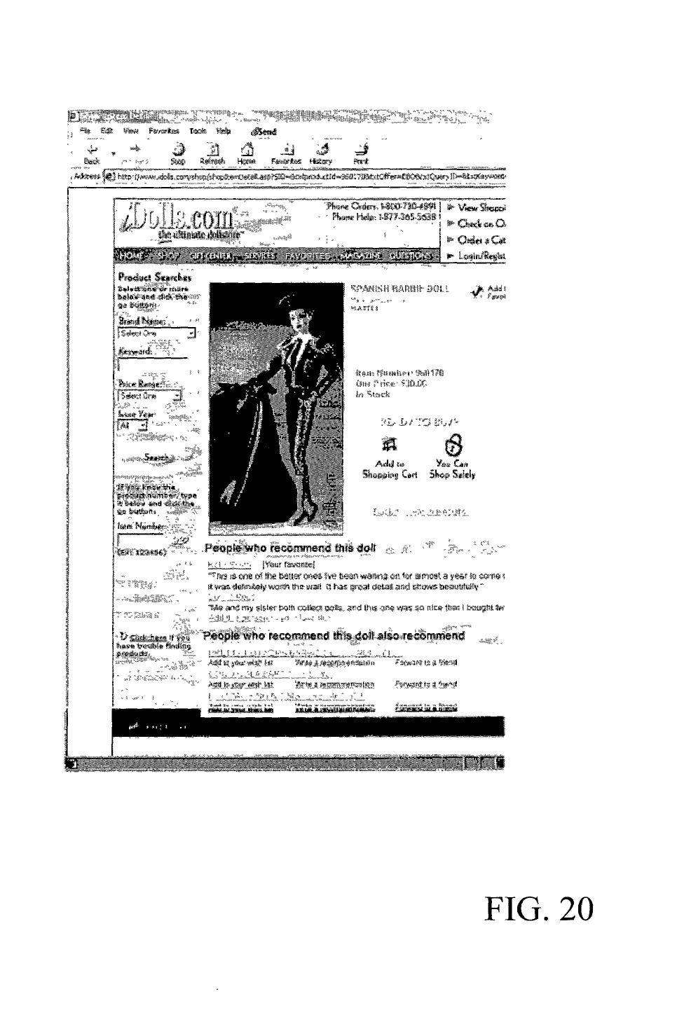

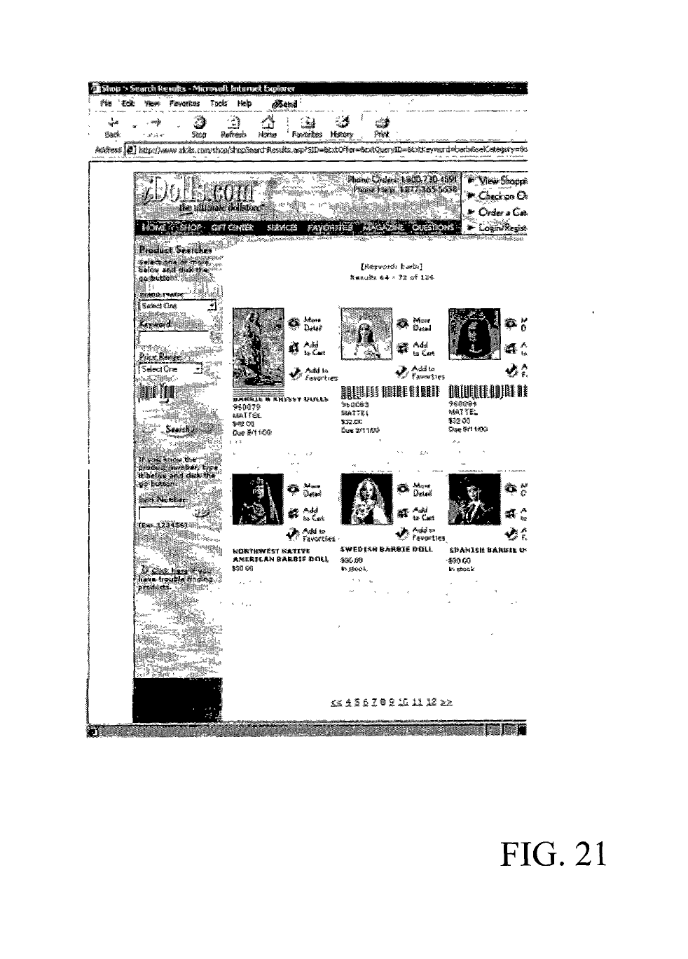

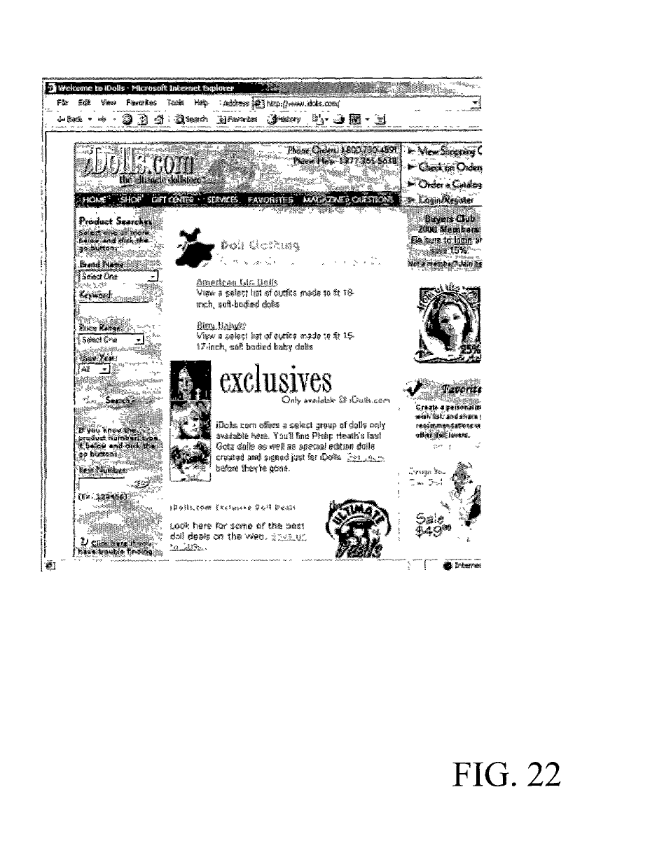

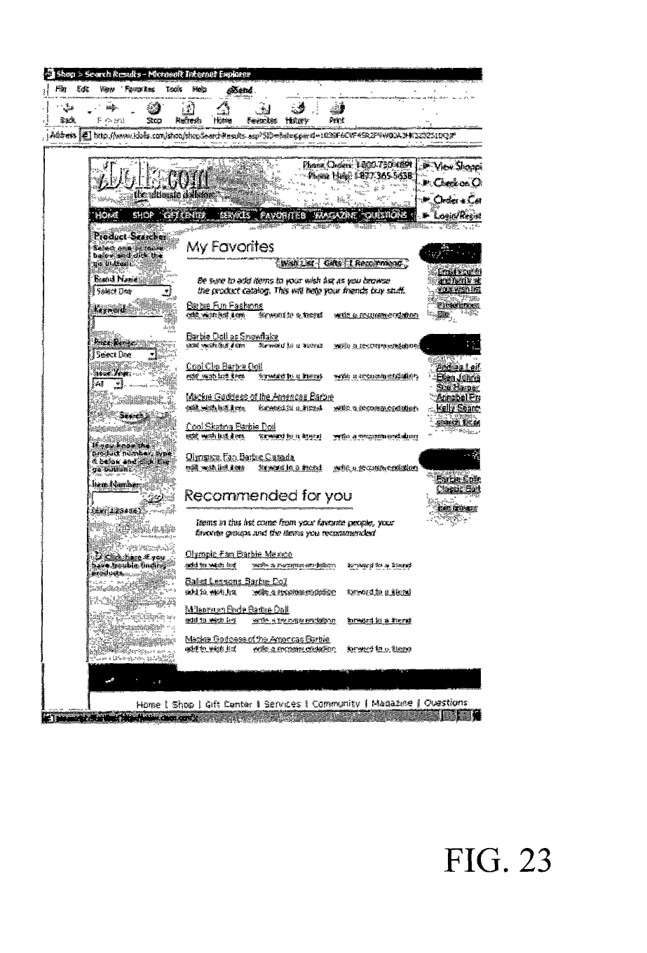

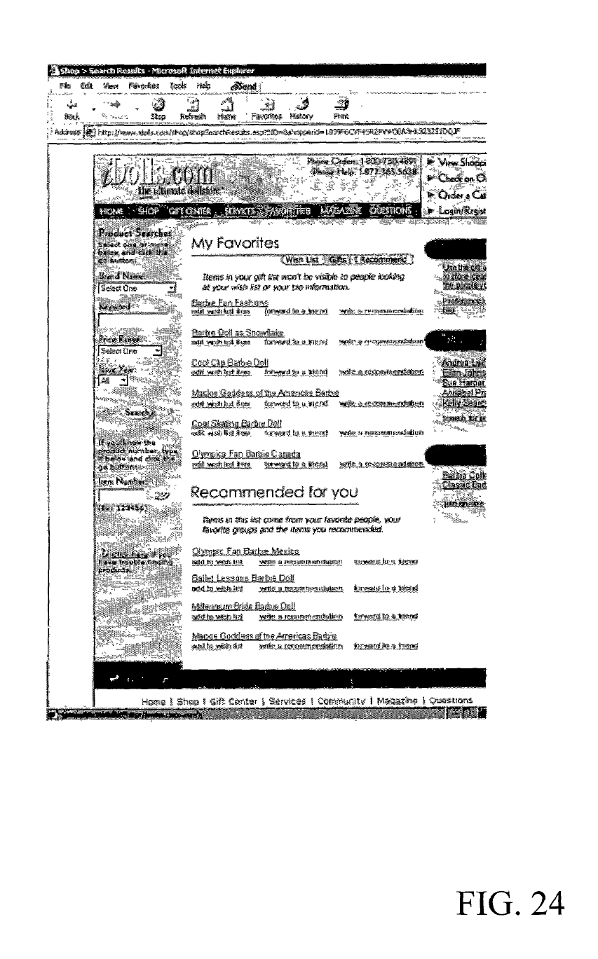

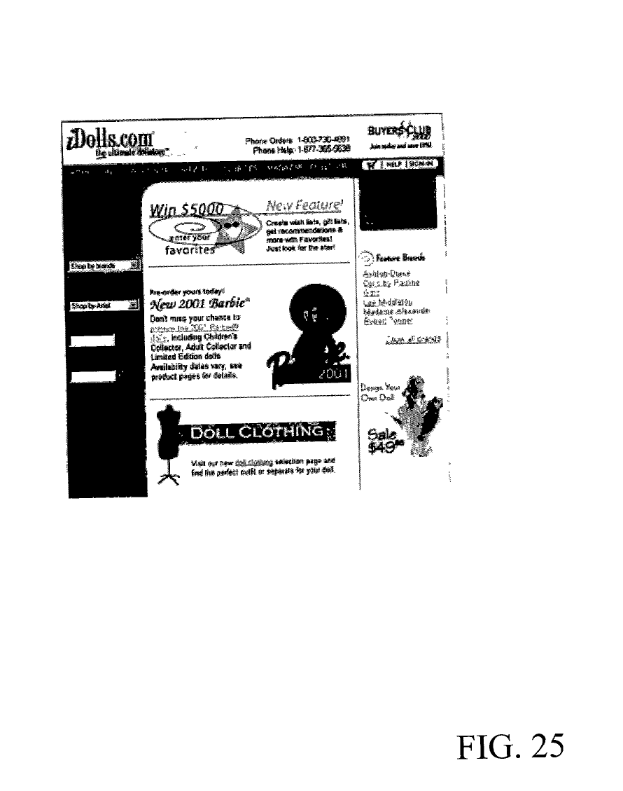

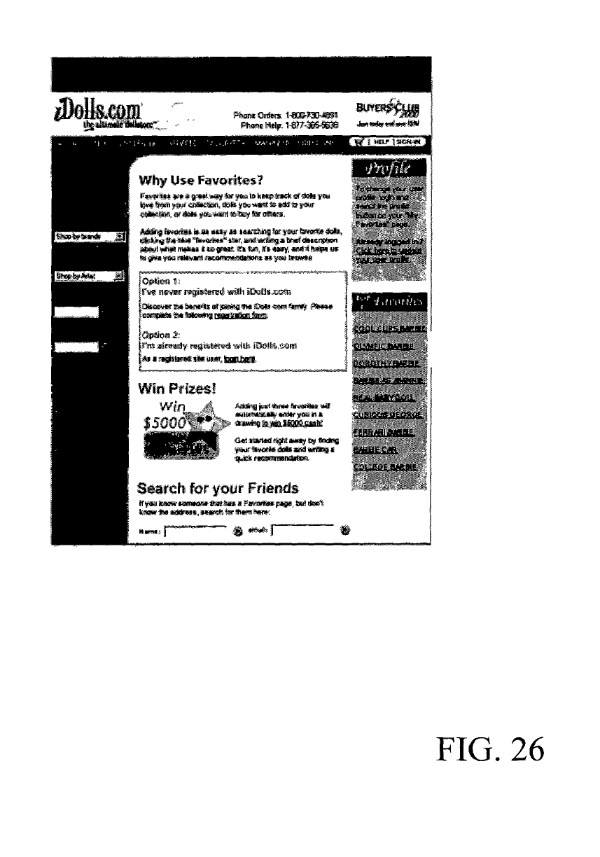

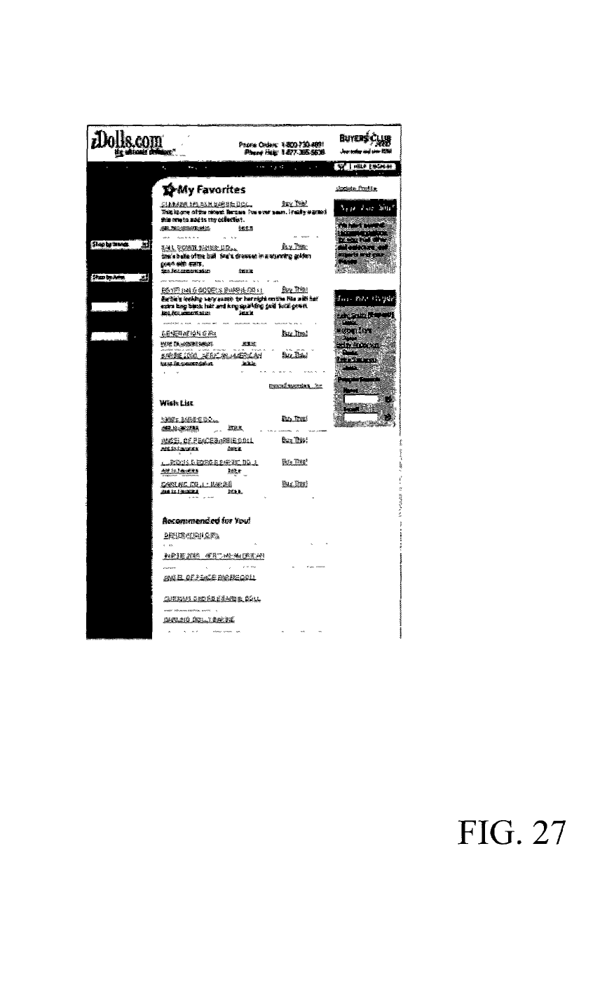

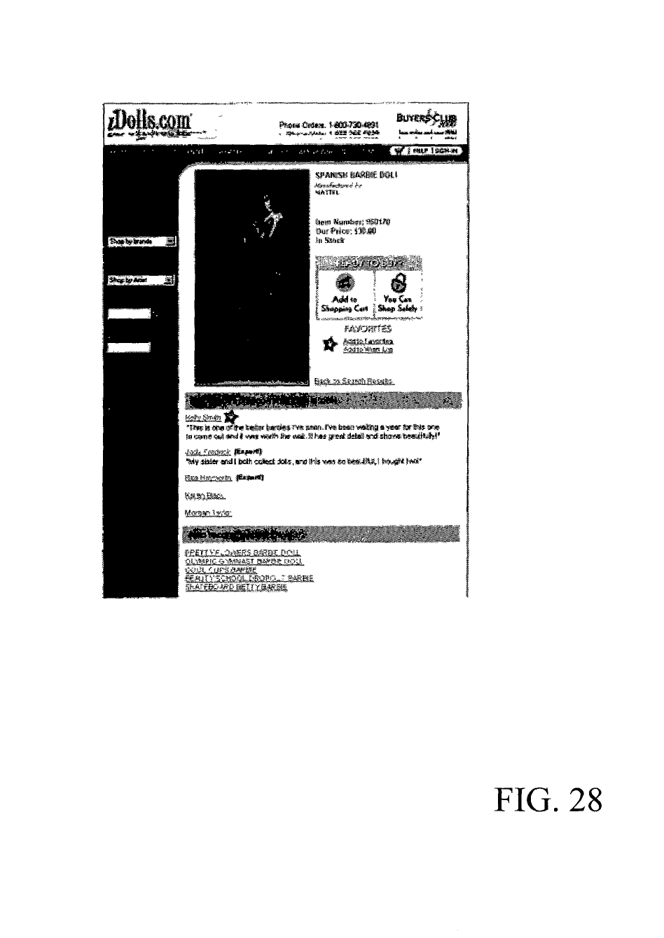

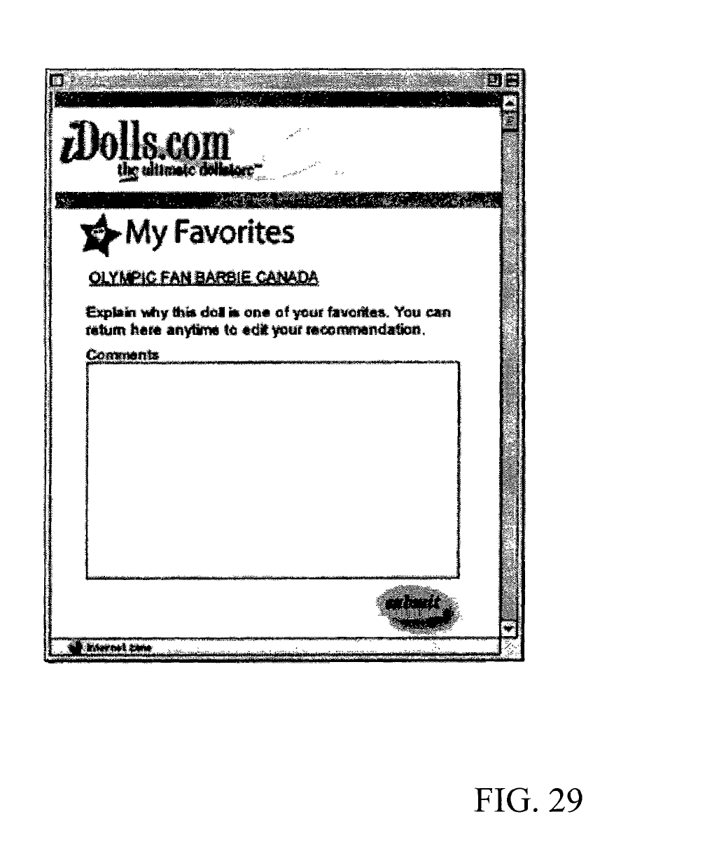

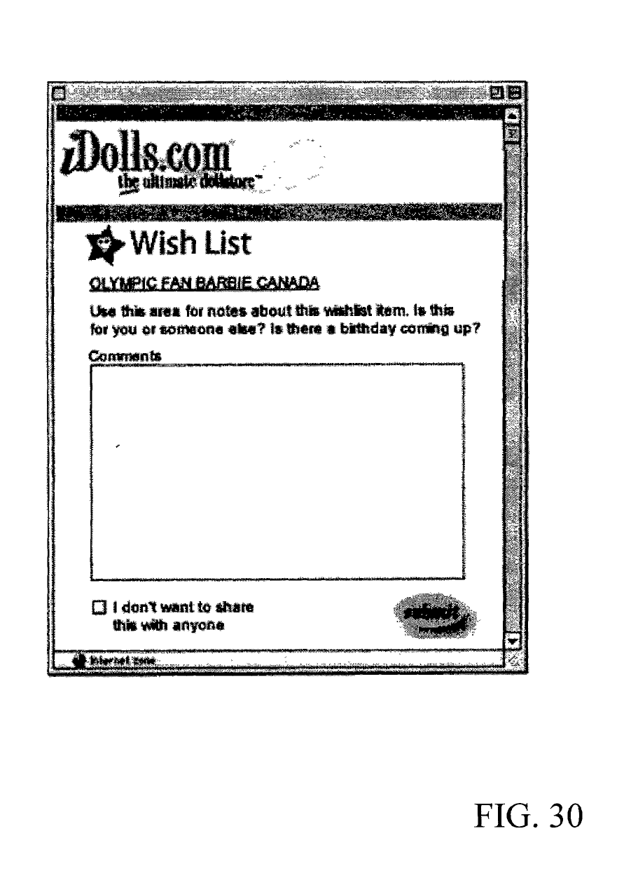

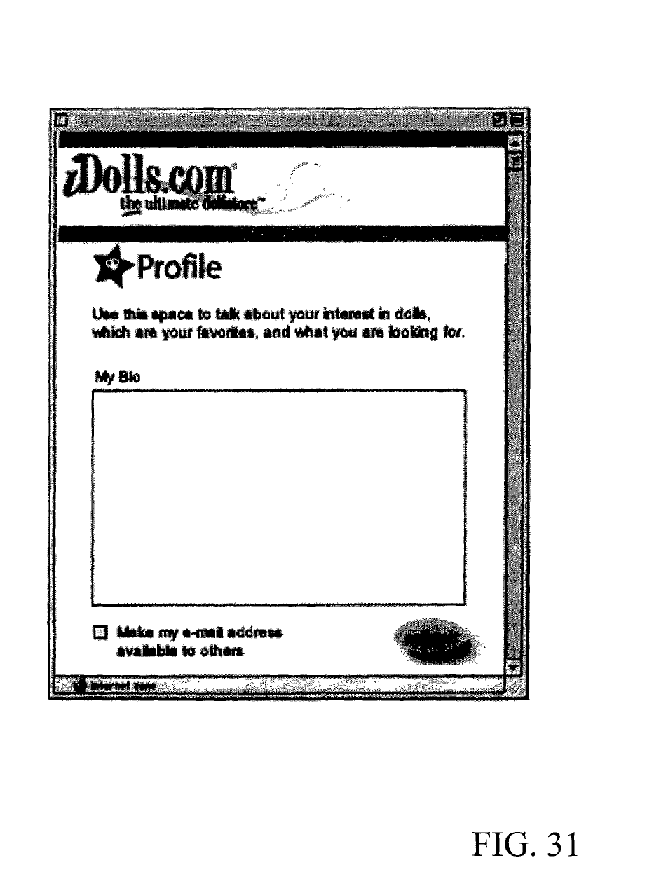

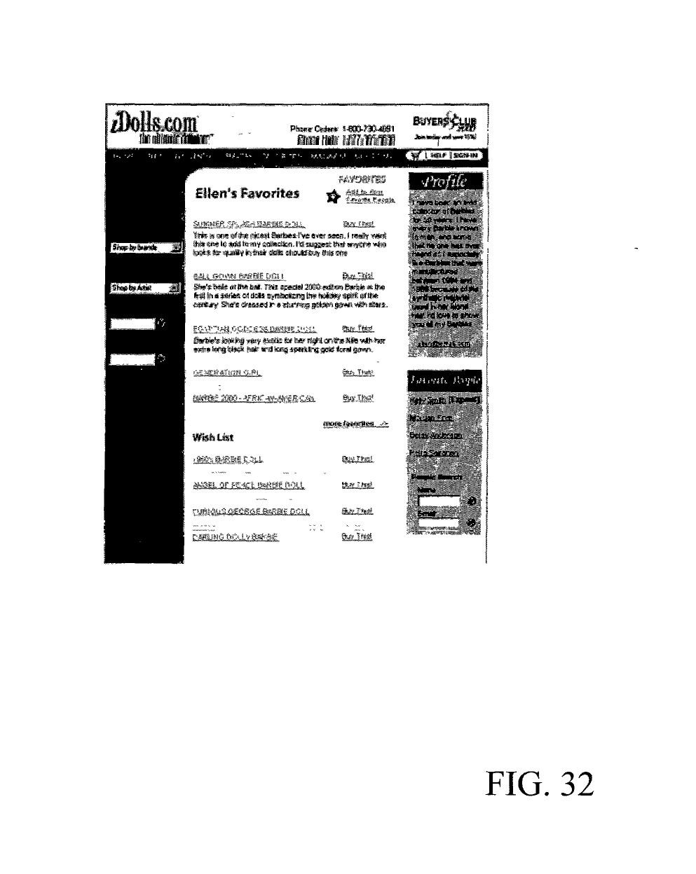

FIGS. 9-32 present various example GUI screens, in accordance with embodiments of the present invention.

The Appendix contains sample driver script for use with a method and system for using collective human intelligence to logically group related items, in accordance with an embodiment of the present invention.

Example embodiments of the present invention have now been described in accordance with the above advantages. It will be appreciated that these examples are merely illustrative of the invention. Many variations and modifications will be apparent to those skilled in the art.

[image]

[image]

[image]

[image]

[image]

[image]

[image]

[image]

[image]

[image]

[image]

[image]

[image]

[image]

[image]

What is claimed is:

1. A method for using collected data for selected products to provide recommendations for additional products to publish at a site on a network, comprising:
collecting the data for the selected products at the network site;
transmitting the data for the selected products from the network site to a server on the network;
parsing and storing the data for the selected products, wherein parsing and storing the data for the selected products includes identifying additional products selected with at least one of the selected products;
identifying data for at least one recommended product, wherein identifying data for at least one recommended product includes incorporation of the identified additional products; and
transmitting the data for the at least one recommended product to the network site for publishing.

2. The method of claim 1, wherein the data for the selected products includes customer selected items placed in a customer shopping cart.

3. The method of claim 1, wherein the data for the selected products is transmitted from the network site to the server via an applet.

4. The method of claim 3, wherein the applet is provided to the network site by the server.

5. The method of claim 3, wherein the applet is a JAVA object.

6. The method of claim 3, wherein the applet is a COM object.

7. The method of claim 1, wherein the data for the selected products comprises a predefined set of attributes.

8. The method of claim 7, wherein the predefined set of attributes include at least one selected from a group consisting of a network site identifier, a product identifier, a product parent identifier, a project universal resource locator (URL), a workstation identification, and a consumer session identification.

9. The method of claim 1, wherein parsing and storing the data includes:
creating a table of products.

10. The method of claim 9, wherein each of the products includes an associated session, such that the products include a plurality of associated sessions, and wherein identifying data for at least one recommended product comprises:
identifying at least one of the associated sessions for at least one of the selected products; and
identifying at least a second one of the selected products for the identified session.

11. The method of claim 1, wherein parsing and storing the data for the selected products comprises:
storing the data for the selected products in a recommendations table.

12. The method of claim 10, wherein identifying at least a second one of the selected products for the identified session produces a number of identified products, and wherein identifying data for at least one recommended product comprises:
limiting the number of identified products.

13. The method of claim 12, wherein incorporation of the determined relationships among the selected products includes:
determining statistically significant products from the identified products for the identified session.

14. The method of claim 1, wherein transmitting the data for at least one recommended product to the network site for publishing includes:
receiving an invoked universal resource locator for the network site; and
transmitting the data for at least one recommended product to the network site for publishing in response to receiving the invoked universal resource locator for the network site.

15. The method of claim 1, wherein the network is the Internet.

16. A system for using collected data for selected products to provide recommendations for additional products to publish, comprising:
a network;
a site coupled to the a network, wherein the additional products to publish are published at the site coupled to the network; and
a server coupled to the network;
wherein the data is collected for the selected products at the site;
wherein the data for the selected products is transmitted from the site to the server;
wherein the data for the selected products is parsed and stored, wherein parsing and storing the data for the selected products includes identifying additional products selected with at least one of the selected products;
wherein data is identified for at least one recommended product, wherein the data for the at least one recommended product is identified by incorporating the identified additional products; and
wherein the data for the at least one recommended product is transmitted to the network site for publishing.

17. The system of claim 16, wherein the network is the Internet.

18. The system of claim 16, wherein the server comprises one selected from a group consisting of a personal computer, a minicomputer, a microcomputer, and a main frame computer.

19. The system of claim 16, wherein the data is collected for the products at the site by the server via the network.
